(19) United States
(12) Patent Application Publication
(10) Pub. No.: US 2026/0330009 A1
(43) Pub. Date: Oct. 22, 2026

(54) ATTACK SURFACE CHANGE IDENTIFICATION MEASUREMENT AND AUTOMATED RESPONSE

(71) Applicant: Wells Fargo Bank, N.A., San Francisco, CA (US)

(72) Inventors: Jerry Joseph Reynolds, Charlotte, NC (US); David Larocco, San Francisco, CA (US); Dennis M. Antunes, Plainville, MA (US); Michael J. Sbandi, Harrisburg, NC (US)

(21) Appl. No.: 19/181,993

(22) Filed: Apr. 17, 2025

(51) Int. Cl. G06F 21/55; G06F 21/56; G06F 21/57

(52) U.S. Cl. CPC G06F 21/552; G06F 21/564; G06F 21/577

(57) ABSTRACT

Systems and techniques may generally be used for identifying attack surfaces in an enterprise environment. An example technique may include identifying a change in a ledger, the ledger storing data corresponding to an application manifest for an application, automatically, using processing circuitry, initiating, in response to identifying the change in the ledger, a security analysis for the application. The security analysis may include determining, using a machine learning trained model whether the change indicates an attack surface for a malicious attack on the application, and outputting an alert when the change indicates an attack surface for a malicious attack on the application. The example technique may include selecting, based on the alert, a script to test the change, configuring the script based on the change and the application manifest, and causing, using the processing circuitry, the script to run on an instance of the application updated based on the change.

### BACKGROUND

Enterprise systems face many attack vectors, such as network threats, social engineering, malware, and authentication vulnerabilities. In addition, internal risks and physical security concerns can add to these risks. Threats frequently change as technology improves, requiring enterprises to update security measures and monitoring. Mitigating these risks is especially challenging because attackers constantly adapt their methods and enterprises must defend against threats while maintaining normal business operations.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a block diagram illustrating attack surfaces and system data for mitigation of attacks in accordance with some examples.

FIG. 2 illustrates a block diagram showing an example ledger storing application data in accordance with some examples.

FIGS. 3A-3B illustrate heatmap visualizations for attack surfaces in an enterprise in accordance with some examples.

FIG. 4 illustrates a machine learning engine for training and execution related to determining an attack surface for a malicious attack on an application in accordance with some examples.

FIG. 5 illustrates a flowchart showing a technique for mitigating an attack based on a vulnerability identified via a change in a ledger in accordance with some examples.

FIG. 6 illustrates a flowchart showing a technique for generating a heatmap visualization of attack surfaces, mitigation controls, and attack values in accordance with some examples.

FIG. 7 illustrates generally an example of a block diagram of a machine upon which any one or more of the techniques discussed herein may perform in accordance with some examples.

### DETAILED DESCRIPTION

The systems and techniques described herein provide for automated attack vector or attack surface identification or mitigation. An attack vector is a way that a malicious actor uses to gain unauthorized access to a computer system, network, or application. An attack vector may be used to deliver a malicious payload or extract sensitive information. An attack surface is a combination of attack vectors, such as a worker (e.g., subject to phishing attacks) and a user device (e.g., subject to malware). In some examples, a single mitigation action or combination of mitigation actions may be used to secure an attack surface (e.g., preventing multiple attack vectors, such as education to the worker to prevent both phishing attacks and malware). The systems and techniques described herein may be used to identify changes to a ledger (e.g., a blockchain ledger) to identify a risk based on a change to the ledger. The ledger may reflect a state of an application or other resource, for example including a software bill of materials (SBOM), an API, a document type, an input parameter, or the like. The risk may be identified from the change in the ledger using a trained machine learning model, such as based on a pattern of past ledger entries. The systems and techniques described herein may be used to generate a heatmap of attack vectors and attack techniques, such as showing a risk level. The heatmap may be used for visualization of attack surfaces for responding to threats enterprise wide.

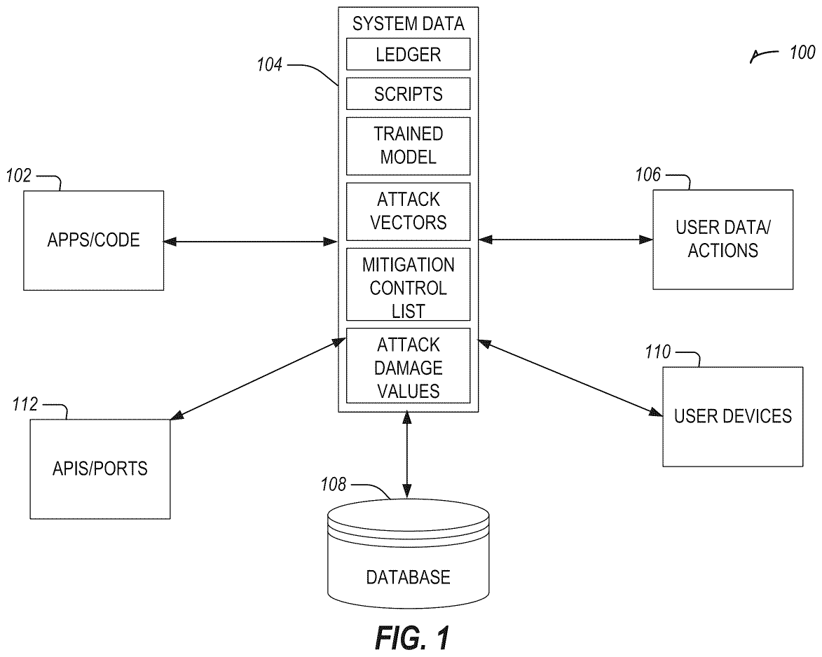

FIG. 1 illustrates a block diagram 100 illustrating attack surfaces and system data for mitigation of attacks in accordance with some examples. The block diagram 100 shows system data 104 that may be used to evaluate changes to a ledger and mitigate attack surfaces. The system data 104 may be stored in a database 108. The system data 104 may receive information from or mitigate attack surfaces at one or more sources, such as applications or code 102, user data or actions 106, user devices 110, APIs or ports 112, or the like. The system data includes a ledger (e.g., a blockchain ledger), which may be used to evaluate changes to one or more components using the techniques described herein. The system data 104 includes scripts 104, which may be used to mitigate an attack surface (e.g., as identified from a change in the ledger). The system data 104 includes a trained model that may be used to detect potential vulnerabilities based on a change in the ledger. The trained model may identify a script to run from the scripts based on a change to the ledger and an identified mitigation. The system data 104 may include known attack vectors that represent possible security threats (e.g., to the one or more components 102, 106, 110, or 112). The system data 104 includes a mitigation control list that identifies currently implemented mitigations, mitigations that are available but that are not yet implemented, mitigations that may be created, or the like. The system data 104 includes attack damage values that indicate potential impacts of attacks (e.g., a monetary value such as a value corresponding to a predicted monetary loss from a successful attack, a value corresponding to a predicted amount of damage to infrastructure, enterprise trust, exposure to legal or regulatory ramifications, a damage amount for a successful attack of a respective attack vector, or the like).

The block diagram 100 illustrates a system that may be used to categorize attack vectors or attack surfaces. The ledger of the system data 104 may include a private blockchain, which may be maintained by an enterprise, such as with inputs from one or more vendors. The ledger may be an immutable and tamper-resistant ledger for software supply chain security, such as for an application. The ledger may include identification of software components. The ledger may be used with versioning standards to leverage different BOMs to identify an attack surface based on a change to the ledger. For example, BOMs may include a crypto BOM, a CycloneDX BOM, a quantum BOM, etc. A change to the ledger may occur over time, for example, changes over time, even if small, may trigger a need to further consider security changes due to a shift in risk. An example BOM for AI agents may identify what models were used, what or whether retrieval augmented generation (RAG) was used, how the AI agent was trained, what the AI agent do to obtain an identification of a vulnerability or remediation, how an output from the AI agent was validated, or the like. The ledger may include an immutable record of a state of details about an application or resource, which may be compared using a hash to identify when a record has been modified. In some examples, nodes of the ledger may be different software suppliers. Companies that provide software to an application or resource may validate their software when sending, which may be written to the ledger.

A change to the ledger may be identified as a change in component or behavior over time of the application. For example, a change may be a new API call, a new input parameter, a new output, etc. In some examples, the change to the ledger may be a transitive dependency change. For example, a change to an input parameter may cause a later output to have an increased risk (e.g., adding an input including personally identifying information may change a risk to data later stored without security measures, such as in plain text). In another example, a change in order for downstream step that assumed prior authentication may trigger a higher risk. In an example, the ledger may enable smart contracts for inputs, or smart contract overlays for parameters used to enhance trust of a supply chain. The ledger may include change detection event alerting for on-chain testing. Change evaluation using a trained machine learning model may be performed periodically or triggered based on a change to the ledger.

In an example, a change may be detected based on a change to a public repository, such as in starjacking where a repository is made to look popular but is not or repojacking where a repository is hijacked to add malicious code. The change in the ledger may indicate a new author or an increase in popularity above a threshold amount in a particular amount of time.

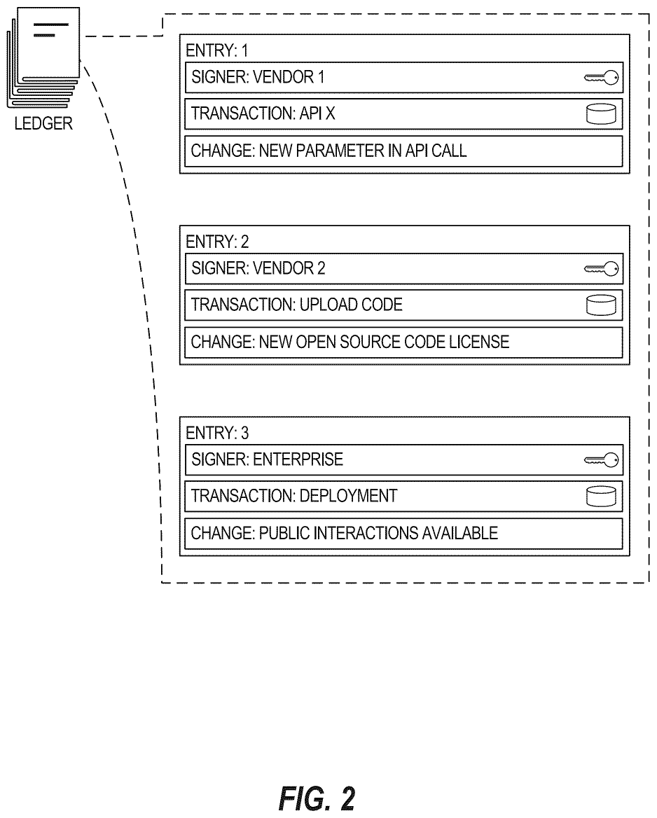

FIG. 2 illustrates a block diagram 200 showing an example ledger storing application data in accordance with some examples. The block diagram 200 shows the example ledger with several example entries, such as a first entry from a first vendor, with a change indicated as a new parameter in an API call. While the entries are shown as identifying the change, in other examples the change may not be shown in the ledger itself but in a separate log (e.g., a change log, for example based on a comparison between a current ledger and a previous ledger). The change may be identified from the ledger by comparing a current entry to a previous entry (e.g., stored in a hash of the ledger or separately stored). A second entry from a second vendor indicates a change of code a code update with a new open source code license. The third entry shows an enterprise change to deployment of code, with a change indicating that public interactions are now possible. The three entries are shown for illustration, but only one may occur at a time in some examples. Each change may be evaluated (e.g., using a trained machine learning model as described herein) to determine whether the change indicates an attack surface for a malicious attack. The attack surface may be identified based on the change itself, based on a history of changes, based on a signer (e.g., a vendor change may be riskier than an enterprise change, generally), based on a timing of an entry, based on past attack surfaces, based on known vulnerabilities, or the like.

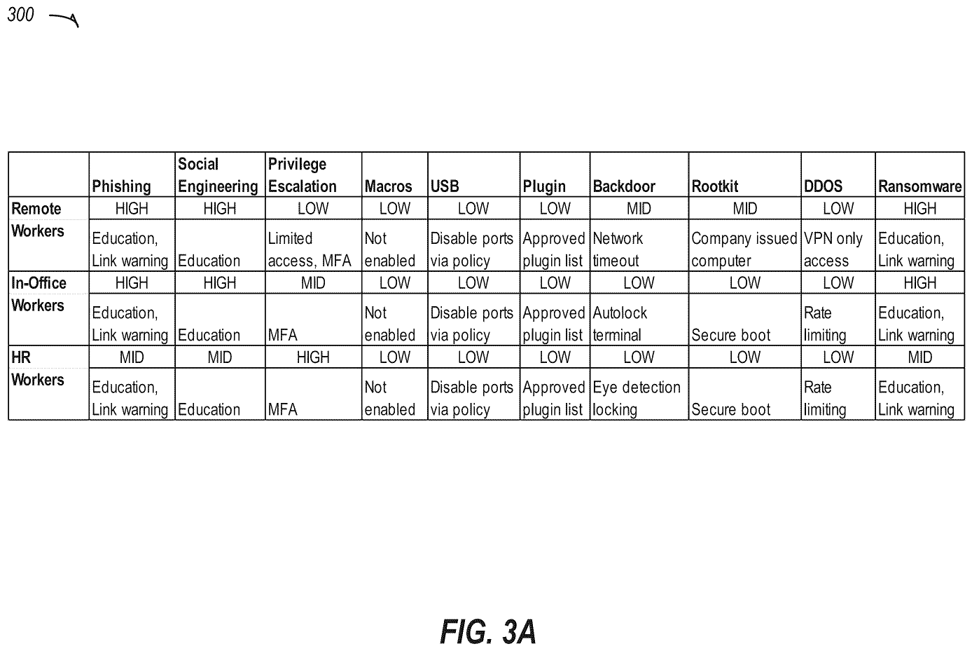

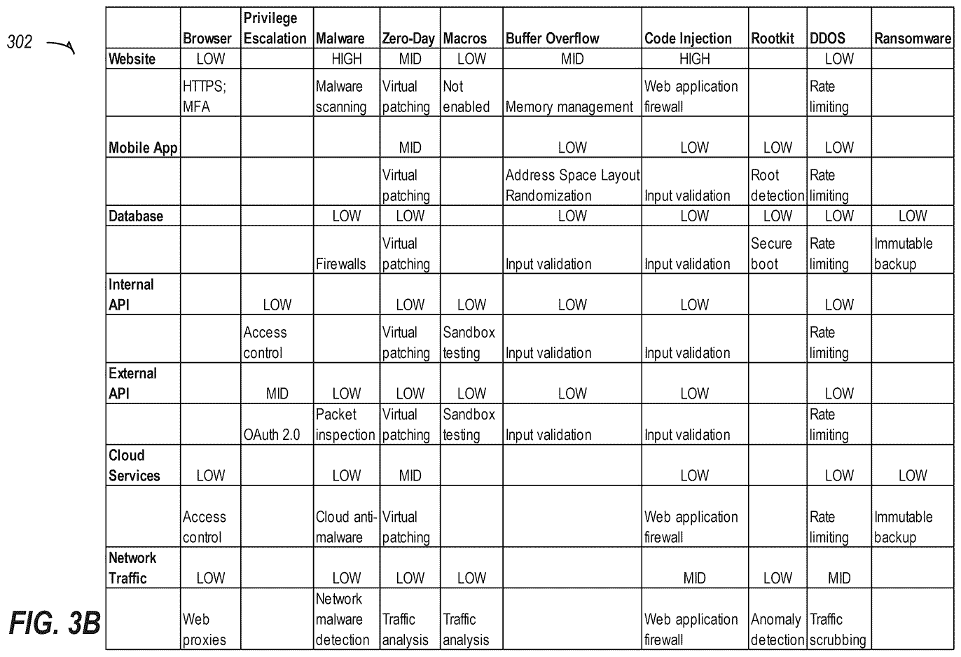

FIGS. 3A-3B illustrate heatmap visualizations for attack surfaces in an enterprise in accordance with some examples. FIG. 3A shows a first heatmap portion 300 of a heatmap, and FIG. 3B shows a second heatmap portion 302 of the heatmap, but these may be displayed together in implementations. In some examples, fewer or more categories may be used, such as fewer or more potential attackable or fewer or more attack vectors (e.g., together attack surfaces) may be used. Not every box may receive a score for the heatmap, or a default may be used (e.g., a low damage indication). The heatmap shown in FIGS. 3A-3B is shown with categorizations (e.g., LOW, MID, HIGH) for convenient presentation in the present application, but other methods of displaying scores may be used in the heatmap. For example, a color gradient or discrete color template for a block (e.g., background or font) may be used (e.g., “cooler” colors such as blues and greens may indicate a lower risk factor, while “hotter” colors such as red or orange may indicate a higher risk factor). Other examples showing a visualization of risk in a combination may include varying text size, block size, bolding/italicizing or other font style, 3D rendering (e.g., a 3D bar chart or bar graph), rearranging the heatmap from riskiest to least risky, or vice versa, ranking by score, or the like.

FIG. 3A illustrates the first heatmap portion 300 including different types of resources (e.g., Remote Workers, In-Office Workers, and HR Workers) against various attack vectors including Phishing, Social Engineering, Privilege Escalation, Macros, USB, Plugin, Backdoor, Rootkit, DDOS, and Ransomware. For each combination, the first heatmap portion 300 indicates a risk level (e.g., HIGH, MID, or LOW) and includes a corresponding mitigation control implemented for that risk (e.g., “Education, Link warning” for Phishing attacks). FIG. 3B illustrates the second heatmap portion 302 including system components (e.g., Website, Mobile App, Database, Internal API, External API, Cloud Services, and Network Traffic) compared with attack vectors such as Browser attacks, Privilege Escalation, Malware, Zero-Day vulnerabilities, etc. For each combination, the second heatmap portion 302 indicates a risk level (e.g., HIGH, MID, or LOW) and includes a corresponding mitigation control implemented for that risk (e.g., firewalls mitigating malware exposure at a database).

The heatmap may include ratings of vulnerability in various components. For risky components, a pen test script may be automatically created to test attack weaknesses. Using the riskier components, an advanced persistent threat (APT) may be simulated to prioritize what components are to be mitigated. Ratings may be generated based on riskiness, potential damages, implemented mitigations, available but not implemented mitigations, etc.

In an example, a trained machine learning model may be used to determine where weaknesses are being exploited, where overall vulnerabilities are, or what mitigations are being used. The model may output an indication of a mitigation to implement, a risk value, a ranking of vulnerabilities, etc. The model may indicate a chain of mitigations or risks, in some examples, a chain risks may be output with an indication of a mitigation to stop the chain. The mitigation to stop the chain may not mitigate all risks in the chain or even the most risky component in the chain, but may prevent an attack using the chain. For example, the model may output a mitigation that is easier to implement that stops the attack rather than a complex mitigation to mitigate a highest risk component. In some examples, the model may cluster vulnerabilities across cyber kill chains. The model may recommend a mitigation that addresses a cluster. In these examples, the mitigation that addresses the cluster may take longer to implement or be more complex, but may address more vulnerabilities, and thus be worth the delay or complexity. The model may be trained using successful attacks, mitigated attacks, indicators of successful exploitations, an attack surface that is exploitable even when a particular attack was not successful, etc.

The heatmap may identify vulnerabilities in an application, an infrastructure, humans, processes, etc. The combination of vulnerabilities for a particular attack surface may be categorized using the heatmap. For example, the heatmap may include a classification that is based on an attack point of view, such as a risk factor for an attacker attacking a particular resource. After identifying a cyber kill chain, a classification in the heatmap may include mitigations. In an example, for a high risk classification in the heatmap, an alert may be output indicating further review is needed or a penetration test may be automatically created for execution. A classification in the heatmap may consider risk to include a predicted dollar loss from an attack. In this example, a risk may be unmitigated but still not classified as a high risk if the likely dollar loss is very low, while an attack with a relatively low likelihood of success may still be classified as a high risk attack when the likely dollar loss is very high. The model may output an automatically mitigation via a script from a playbook when a new cyber kill chain is identified.

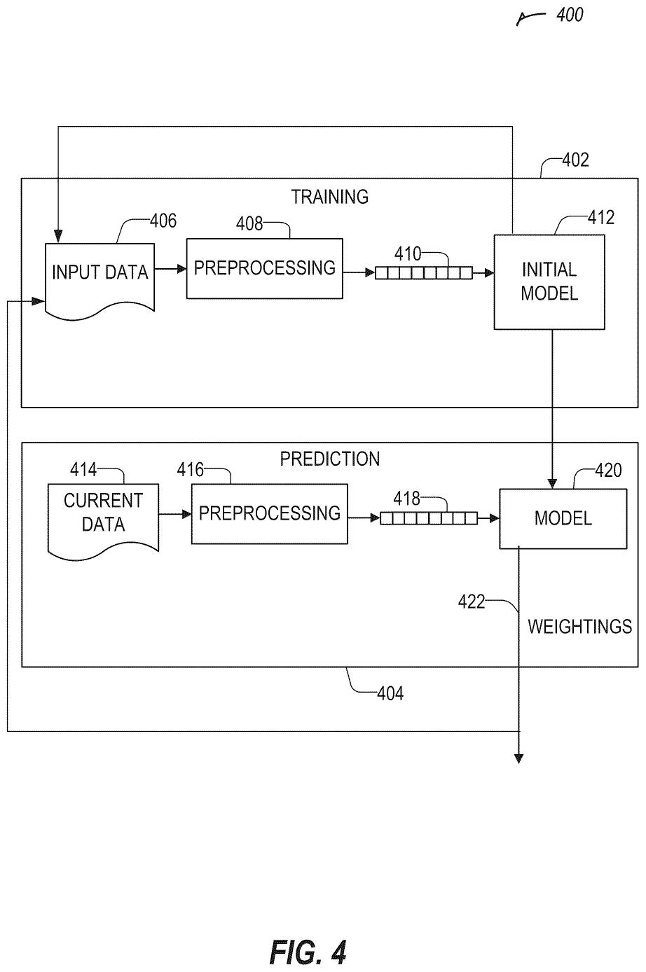

FIG. 4 illustrates a machine learning engine for training and execution related to determining an attack surface for a malicious attack on an application in accordance with some examples. The machine learning engine may be deployed to execute at a mobile device (e.g., a cell phone, a tablet, etc.) or a computer (e.g., a desktop, a laptop, etc.). FIG. 4 shows an example machine learning engine 400 according to some examples of the present disclosure.

Machine learning engine 400 uses a training engine 402 and a prediction engine 404. Training engine 402 uses input data 406, for example after undergoing preprocessing component 408, to determine one or more features 410. The one or more features 410 may be used to generate an initial model 412, which may be updated iteratively or with future labeled or unlabeled data (e.g., during reinforcement learning), for example to improve the performance of the prediction engine 404 or the initial model 412. An improved model may be redeployed for use.

The input data 406 may include changes to ledger, such as a change to the SBOM, a new API, a change in document type access, an input parameter change, a pattern of past ledger entries, or the like.

In the prediction engine 404, current data 414 (e.g., a ledger, a set of ledgers, a change log of a ledger, or the like) may be input to preprocessing component 416. In some examples, preprocessing component 416 and preprocessing component 408 are the same. The prediction engine 404 produces feature vector 418 from the preprocessed current data, which is input into the model 420 to generate one or more criteria weightings 422. The criteria weightings 422 may be used to output a prediction, as discussed further below.

The training engine 402 may operate in an offline manner to train the model 420 (e.g., on a server). The prediction engine 404 may be designed to operate in an online manner (e.g., in real-time, at a mobile device, on a wearable device, etc.). In some examples, the model 420 may be periodically updated via additional training (e.g., via updated input data 406 or based on labeled or unlabeled data output in the weightings 422) or based on identified future data, such as by using reinforcement learning to personalize a general model (e.g., the initial model 412) to a particular user. Labels for the input data 406 may include whether a change indicates a malicious attack.

The initial model 412 may be updated using further input data 406 until a satisfactory model 420 is generated. The model 420 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 402 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 402. In an example embodiment, a regression model is used and the model 420 is a vector of coefficients corresponding to a learned importance for each of the features in the vector of features 410, 418. A reinforcement learning model may use Q-Learning, a deep Q network, a Monte Carlo technique including policy evaluation and policy improvement, a State-Action-Reward-State-Action (SARSA), a Deep Deterministic Policy Gradient (DDPG), or the like.

Once trained, the model 420 may output a prediction, such as whether a change in a ledger indicates an attack surface for a malicious attack on the application.

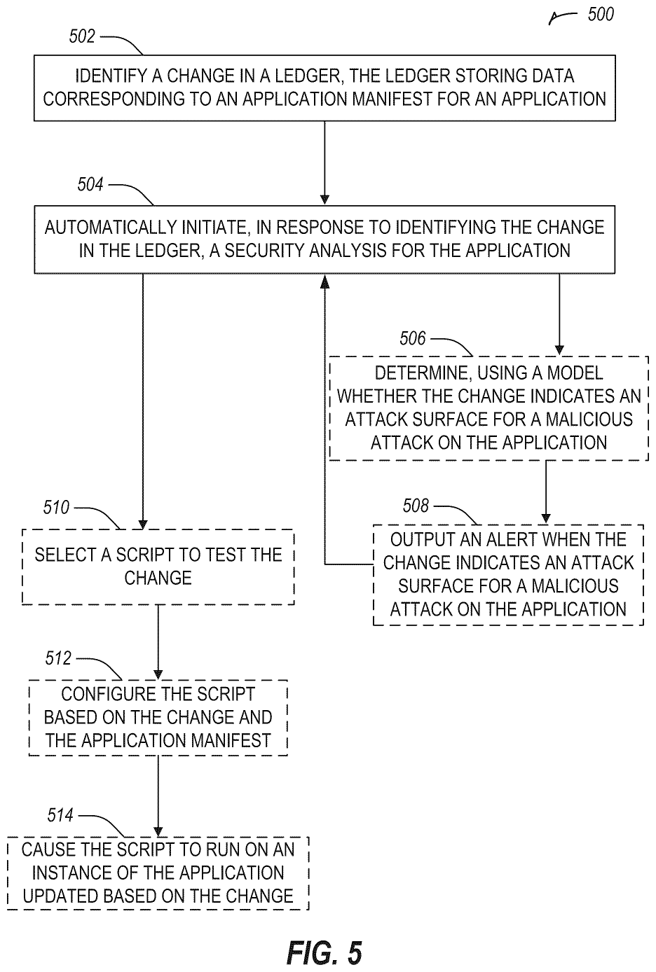

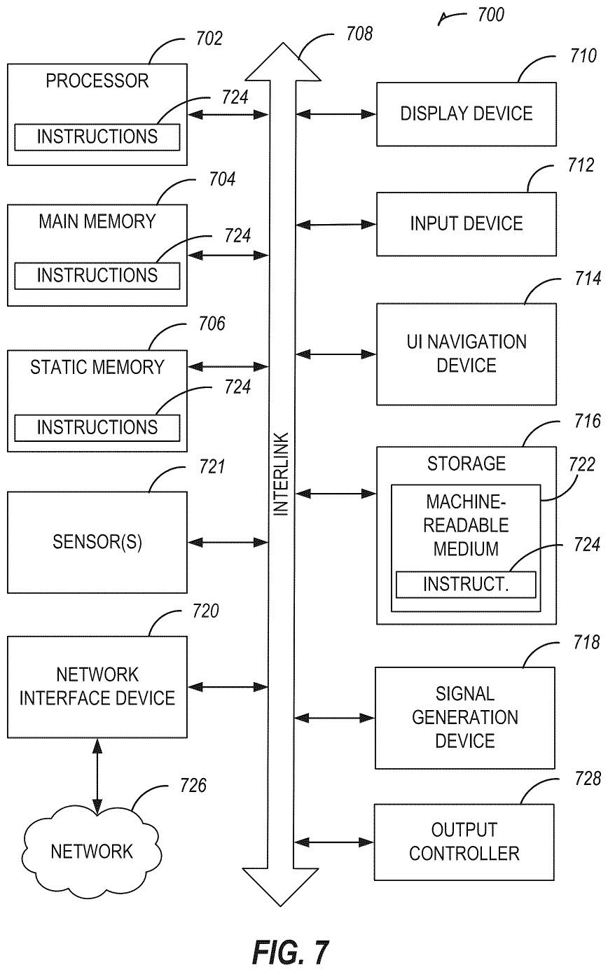

FIG. 5 illustrates a flowchart showing a technique for mitigating an attack based on a vulnerability identified via a change in a ledger in accordance with some examples. In an example, operations of the technique 500 may be performed by processing circuitry, for example by executing instructions stored in memory. The processing circuitry may include a processor, a system on a chip, or other circuitry (e.g., wiring). For example, technique 500 may be performed by processing circuitry of a device (or one or more hardware or software components thereof), such as those illustrated and described with reference to FIG. 7.

The technique 500 includes an operation 502 to identify a change in a ledger, the ledger storing data corresponding to an application manifest for an application. Identifying the change in the ledger may include identifying a pre-commit change based on an instance of the application running in a protected environment. The ledger may include a software bill of materials, for example including an entry originating from at least one third party and an entry from a primary developer of the application.

The technique 500 includes an operation 504 to automatically initiate, in response to identifying the change in the ledger, a security analysis for the application. The security analysis may include determining whether the change includes malicious code. When malicious code is identified, an alert may be output in response (e.g., identifying the malicious code).

The technique 500 includes an optional operation 506 as part of operation 504 to determine, using a model whether the change indicates an attack surface for a malicious attack on the application. The change may be identified from an introduction of a new security issue, a change from a secure to an insecure component, document, input, API call, etc., or the like. Operation 506 may include determining at least one of a new API, a change in document type access, or an input parameter change. Operation 506 may include determining a pattern of past ledger entries indicates an attack surface for a malicious attack.

The technique 500 includes an optional operation 508 as part of operation 504 to output an alert when the change indicates an attack surface for a malicious attack on the application. Operation 508 may include displaying the alert on a user device. Operation 508 may include displaying a heatmap visualization overlay of the attack surface.

The technique 500 includes an optional operation 510 to select a script to test the change (e.g., based on the alert of operation 508, when used). The script may be selected from a database (e.g., storing a plurality of scripts). The script may be selected based on an output of the machine learning model, which may for example, output an indication of a script identifier or script type based on the change (e.g., for a new API call, a script may be selected to test the API call). The technique 500 includes an optional operation 512 to configure the script based on the change and the application manifest. The technique 500 includes an optional operation 514 to cause the script to run on an instance of the application updated based on the change. Operation 514 may include automatically creating a penetration test for the application and running the penetration test for the application.

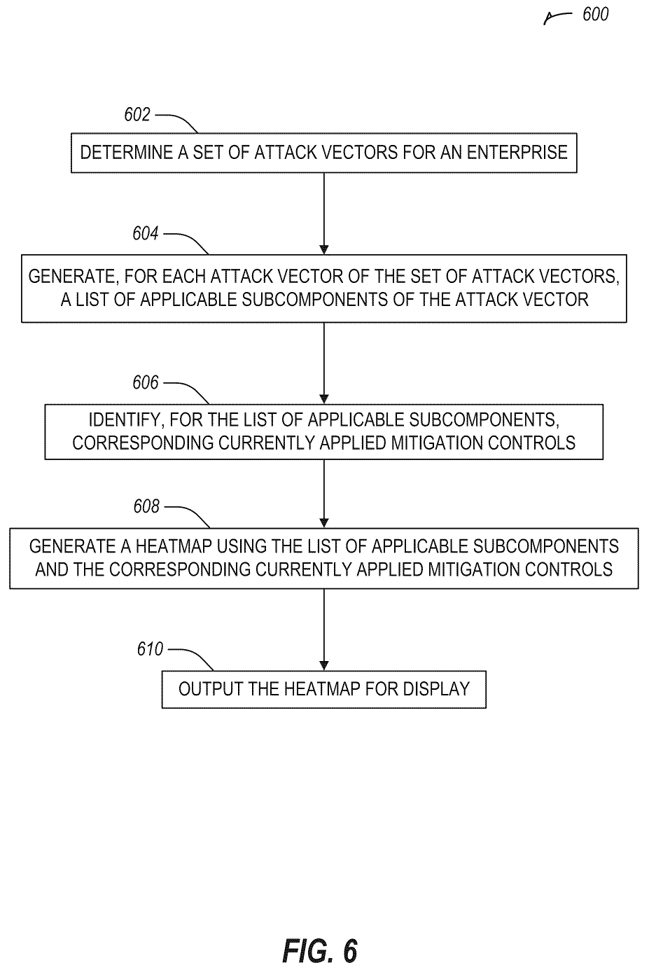

FIG. 6 illustrates a flowchart showing a technique for generating a heatmap visualization of attack surfaces, mitigation controls, and attack values in accordance with some examples. In an example, operations of the technique 600 may be performed by processing circuitry, for example by executing instructions stored in memory. The processing circuitry may include a processor, a system on a chip, or other circuitry (e.g., wiring). For example, technique 600 may be performed by processing circuitry of a device (or one or more hardware or software components thereof), such as those illustrated and described with reference to FIG. 7.

The technique 600 includes an operation 602 to determine a set of attack vectors for an enterprise. An attack vector may include a vulnerability, such as a social engineering attack, a hardware, software, or firmware vulnerability, a browser-based attack, etc. The technique 600 includes an operation 604 to generate, for each attack vector of the set of attack vectors, a list of applicable subcomponents of the attack vector. The subcomponents may include individual humans or a job title, a component of hardware, an application, an API call, a parameter of an application, stored data, a database, or the like. The technique 600 includes an operation 606 to identify, for the list of applicable subcomponents, corresponding currently applied mitigation controls. Mitigation controls may include education, a firewall, a secure testing environment, a limit on an API call, a security scan for a virus, malware, or other malicious code, or the like.

The technique 600 includes an operation 608 to generate a heatmap using the list of applicable subcomponents and the corresponding currently applied mitigation controls. The heatmap may include a shading or color coding for each subcomponent in the list of applicable subcomponents based on the corresponding currently applied mitigation controls and an attack value for a respective attack vector of the subcomponent. The attack value may be a monetary value (e.g., a value corresponding to a predicted monetary loss from a successful attack). The attack value may include a value corresponding to a predicted amount of damage to infrastructure, enterprise trust, exposure to legal or regulatory ramifications, or the like. The attack value may include a damage amount for a successful attack of the respective attack vector. Shading or color coding of the heatmap may be generated using a set of available mitigation controls not yet applied to an attack vector or a subcomponent. Shading or color coding of the heatmap may be generated using a time to generate a new mitigation control. Shading or color coding of the heatmap may be generated using a weighting for subcomponents based on a number of attack vectors in the set of attack vectors that affect by the subcomponent.

The technique 600 includes an operation 610 to output the heatmap for display. The technique 600 may include outputting a recommendation for a penetration test on a particular subcomponent based on the heatmap. The technique 600 may include identifying a change in a ledger, the ledger storing data corresponding to an application manifest for an application, and automatically initiating, in response to identifying the change in the ledger, a security analysis for the application. The security analysis may include determining, using a machine learning trained model whether the change indicates an attack surface for a malicious attack on the application and outputting an alert when the change indicates an attack surface for a malicious attack on the application.

FIG. 7 illustrates generally an example of a block diagram of a machine upon which any one or more of the techniques discussed herein may perform, according to various examples. In alternative embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environment. The machine 700 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the execution units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a display unit 710, an alphanumeric input device 712 (e.g., a keyboard), and a user interface (UI) navigation device 714 (e.g., a mouse). In an example, the display unit 710, alphanumeric input device 712 and UI navigation device 714 may be a touch screen display. The machine 700 may additionally include a storage device (e.g., drive unit) 716, a signal generation device 718 (e.g., a speaker), a network interface device 720, and one or more sensors 721, such as a global positioning system (GPS) sensor, compass, accelerometer, or other sensor. The machine 700 may include an output controller 728, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 716 may include a machine readable medium 722 that is non-transitory on which is stored one or more sets of data structures or instructions 724 (e.g., software) embodying or utilized by any one or more of the techniques or functions described herein. The instructions 724 may also reside, completely or at least partially, within the main memory 704, within static memory 706, or within the hardware processor 702 during execution thereof by the machine 700. In an example, one or any combination of the hardware processor 702, the main memory 704, the static memory 706, or the storage device 716 may constitute machine readable media.

While the machine readable medium 722 is illustrated as a single medium, the term “machine readable medium” may include a single medium or multiple media (e.g., a centralized or distributed database, or associated caches and servers) configured to store the one or more instructions 724.

The term “machine readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device 720 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 720 may include one or more physical jacks (e.g., Ethernet, coaxial, or phone jacks) or one or more antennas to connect to the communications network 726. In an example, the network interface device 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700, and includes digital or analog communications signals or other intangible medium to facilitate communication of such software.

The following, non-limiting examples, detail certain aspects of the present subject matter to solve the challenges and provide the benefits discussed herein, among others.

Example 1 is a method comprising: identifying a change in a ledger, the ledger storing data corresponding to an application manifest for an application; automatically, using processing circuitry, initiating, in response to identifying the change in the ledger, a security analysis for the application, the security analysis including: determining, using a machine learning trained model whether the change indicates an attack surface for a malicious attack on the application; and outputting an alert when the change indicates an attack surface for a malicious attack on the application; selecting, based on the alert, a script to test the change; configuring the script based on the change and the application manifest; and causing, using the processing circuitry, the script to run on an instance of the application updated based on the change.

In Example 2, the subject matter of Example 1 includes, wherein, the security analysis includes determining whether the change includes malicious code, and wherein outputting the alert in response to determining that the change includes malicious code.

In Example 3, the subject matter of Examples 1-2 includes, wherein determining, using the machine learning model that the change indicates an attack surface for a malicious attack on the application includes determining at least one of a new API, a change in document type access, or an input parameter change.

In Example 4, the subject matter of Examples 1-3 includes, wherein determining, using the machine learning model that the change indicates an attack surface for a malicious attack on the application includes determining a pattern of past ledger entries indicates an attack surface for a malicious attack.

In Example 5, the subject matter of Examples 1-4 includes, wherein causing the script to run on an instance of the application updated based on the change includes automatically creating a penetration test for the application and running the penetration test for the application.

In Example 6, the subject matter of Examples 1-5 includes, wherein outputting the alert includes displaying the alert on a user device.

In Example 7, the subject matter of Examples 1-6 includes, wherein identifying the change in the ledger includes identifying a pre-commit change based on an instance of the application running in a protected environment.

In Example 8, the subject matter of Examples 1-7 includes, wherein the ledger includes a software bill of materials including an entry originating from at least one third party and an entry from a primary developer of the application.

In Example 9, the subject matter of Examples 1-8 includes, wherein outputting the alert includes displaying a heatmap visualization overlay of the attack surface.

Example 10 is at least one non-transitory machine-readable medium including instructions, which when executed cause processing circuitry to perform operations comprising: identifying a change in a ledger, the ledger storing data corresponding to an application manifest for an application; automatically initiating, in response to identifying the change in the ledger, a security analysis for the application, the security analysis including: determining, using a machine learning trained model whether the change indicates an attack surface for a malicious attack on the application; and outputting an alert when the change indicates an attack surface for a malicious attack on the application; selecting, based on the alert, a script to test the change; configuring the script based on the change and the application manifest; and causing the script to run on an instance of the application updated based on the change.

In Example 11, the subject matter of Example 10 includes, wherein, the security analysis includes determining whether the change includes malicious code, and wherein outputting the alert in response to determining that the change includes malicious code.

In Example 12, the subject matter of Examples 10-11 includes, wherein determining, using the machine learning model that the change indicates an attack surface for a malicious attack on the application includes determining at least one of a new API, a change in document type access, or an input parameter change.

In Example 13, the subject matter of Examples 10-12 includes, wherein determining, using the machine learning model that the change indicates an attack surface for a malicious attack on the application includes determining a pattern of past ledger entries indicates an attack surface for a malicious attack.

In Example 14, the subject matter of Examples 10-13 includes, wherein causing the script to run on an instance of the application updated based on the change includes automatically creating a penetration test for the application and running the penetration test for the application.

In Example 15, the subject matter of Examples 10-14 includes, wherein outputting the alert includes displaying the alert on a user device.

In Example 16, the subject matter of Examples 10-15 includes, wherein identifying the change in the ledger includes identifying a pre-commit change based on an instance of the application running in a protected environment.

In Example 17, the subject matter of Examples 10-16 includes, wherein the ledger includes a software bill of materials including an entry originating from at least one third party and an entry from a primary developer of the application.

In Example 18, the subject matter of Examples 10-17 includes, wherein outputting the alert includes displaying a heatmap visualization overlay of the attack surface.

Example 19 is a system comprising: storage to store a ledger, including updates to the ledger over time; processing circuitry; and memory, including instructions, which when executed by the processing circuitry, cause the processing circuitry to perform operations comprising: retrieving a ledger from the storage; identifying a change in the ledger, the ledger storing data corresponding to an application manifest for an application; automatically initiating, in response to identifying the change in the ledger, a security analysis for the application, the security analysis including: determining, using a machine learning trained model whether the change indicates an attack surface for a malicious attack on the application; and outputting an alert when the change indicates an attack surface for a malicious attack on the application; selecting, based on the alert, a script to test the change; configuring the script based on the change and the application manifest; and causing the script to run on an instance of the application updated based on the change.

In Example 20, the subject matter of Example 19 includes, wherein, the security analysis includes determining whether the change includes malicious code, and wherein outputting the alert in response to determining that the change includes malicious code.

Example 21 is a method comprising: determining a set of attack vectors for an enterprise; generating, for each attack vector of the set of attack vectors, a list of applicable subcomponents of the attack vector; identifying, for the list of applicable subcomponents, corresponding currently applied mitigation controls; generating a heatmap using the list of applicable subcomponents and the corresponding currently applied mitigation controls, the heatmap including a shading or color coding for each subcomponent in the list of applicable subcomponents based on the corresponding currently applied mitigation controls and an attack value for a respective attack vector of the subcomponent; and output the heatmap for display.

In Example 22, the subject matter of Example 21 includes, wherein the attack value includes a damage amount for a successful attack of the respective attack vector.

In Example 23, the subject matter of Examples 21-22 includes, wherein shading or color coding of the heatmap is generated using a set of available mitigation controls not yet applied to an attack vector or a subcomponent.

In Example 24, the subject matter of Examples 21-23 includes, wherein shading or color coding of the heatmap is generated using a time to generate a new mitigation control.

In Example 25, the subject matter of Examples 21-24 includes, wherein shading or color coding of the heatmap is generated using a weighting for subcomponents based on a number of attack vectors in the set of attack vectors that affect by the subcomponent.

In Example 26, the subject matter of Examples 21-25 includes, outputting a recommendation for a penetration test on a particular subcomponent based on the heatmap.

In Example 27, the subject matter of Examples 21-26 includes, identifying a change in a ledger, the ledger storing data corresponding to an application manifest for an application; and automatically initiating, in response to identifying the change in the ledger, a security analysis for the application.

In Example 28, the subject matter of Example 27 includes, wherein the security analysis includes: determining, using a machine learning trained model whether the change indicates an attack surface for a malicious attack on the application; and outputting an alert when the change indicates an attack surface for a malicious attack on the application.

Example 29 is at least one machine-readable medium including instructions that, when executed by processing circuitry, cause the processing circuitry to perform operations to implement of any of Examples 1-28.

Example 30 is an apparatus comprising means to implement of any of Examples 1-28.

Example 31 is a system to implement of any of Examples 1-28.

Example 32 is a method to implement of any of Examples 1-28.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A method comprising:
identifying a change in a ledger, the ledger storing data corresponding to an application manifest for an application;
automatically, using processing circuitry, initiating, in response to identifying the change in the ledger, a security analysis for the application, the security analysis including:
determining, using a machine learning trained model whether the change indicates an attack surface for a malicious attack on the application; and
outputting an alert when the change indicates the attack surface for a malicious attack on the application;
selecting, based on the alert, a script to test the change;
configuring the script based on the change and the application manifest; and
causing, using the processing circuitry, the script to run on an instance of the application updated based on the change.

2. The method of claim 1, wherein, the security analysis includes determining whether the change includes malicious code, and wherein outputting the alert in response to determining that the change includes malicious code.

3. The method of claim 1, wherein determining, using the machine learning model that the change indicates an attack surface for a malicious attack on the application includes determining at least one of a new API, a change in document type access, or an input parameter change.

4. The method of claim 1, wherein determining, using the machine learning model that the change indicates an attack surface for a malicious attack on the application includes determining a pattern of past ledger entries indicates an attack surface for a malicious attack.

5. The method of claim 1, wherein causing the script to run on an instance of the application updated based on the change includes automatically creating a penetration test for the application and running the penetration test for the application.

6. The method of claim 1, wherein outputting the alert includes displaying the alert on a user device.

7. The method of claim 1, wherein identifying the change in the ledger includes identifying a pre-commit change based on an instance of the application running in a protected environment.

8. The method of claim 1, wherein the ledger includes a software bill of materials including an entry originating from at least one third party and an entry from a primary developer of the application.

9. The method of claim 1, wherein outputting the alert includes displaying a heatmap visualization overlay of the attack surface.

10. At least one non-transitory machine-readable medium including instructions, which when executed cause processing circuitry to perform operations comprising:
identifying a change in a ledger, the ledger storing data corresponding to an application manifest for an application;
automatically initiating, in response to identifying the change in the ledger, a security analysis for the application, the security analysis including:
determining, using a machine learning trained model whether the change indicates an attack surface for a malicious attack on the application; and
outputting an alert when the change indicates an attack surface for a malicious attack on the application;
selecting, based on the alert, a script to test the change;
configuring the script based on the change and the application manifest; and
causing the script to run on an instance of the application updated based on the change.

11. The at least one non-transitory machine-readable medium of claim 10, wherein, the security analysis includes determining whether the change includes malicious code, and wherein outputting the alert in response to determining that the change includes malicious code.

12. The at least one non-transitory machine-readable medium of claim 10, wherein determining, using the machine learning model that the change indicates an attack surface for a malicious attack on the application includes determining at least one of a new API, a change in document type access, or an input parameter change.

13. The at least one non-transitory machine-readable medium of claim 10, wherein determining, using the machine learning model that the change indicates an attack surface for a malicious attack on the application includes determining a pattern of past ledger entries indicates an attack surface for a malicious attack.

14. The at least one non-transitory machine-readable medium of claim 10, wherein causing the script to run on an instance of the application updated based on the change includes automatically creating a penetration test for the application and running the penetration test for the application.

15. The at least one non-transitory machine-readable medium of claim 10, wherein outputting the alert includes displaying the alert on a user device.

16. The at least one non-transitory machine-readable medium of claim 10, wherein identifying the change in the ledger includes identifying a pre-commit change based on an instance of the application running in a protected environment.

17. The at least one non-transitory machine-readable medium of claim 10, wherein the ledger includes a software bill of materials including an entry originating from at least one third party and an entry from a primary developer of the application.

18. The at least one non-transitory machine-readable medium of claim 10, wherein outputting the alert includes displaying a heatmap visualization overlay of the attack surface.

19. A system comprising:
storage to store a ledger, including updates to the ledger over time;
processing circuitry; and
memory, including instructions, which when executed by the processing circuitry, cause the processing circuitry to perform operations comprising:
retrieving a ledger from the storage;
identifying a change in the ledger, the ledger storing data corresponding to an application manifest for an application;
automatically initiating, in response to identifying the change in the ledger, a security analysis for the application, the security analysis including:
determining, using a machine learning trained model whether the change indicates an attack surface for a malicious attack on the application; and
outputting an alert when the change indicates the attack surface for a malicious attack on the application;
selecting, based on the alert, a script to test the change;
configuring the script based on the change and the application manifest; and
causing the script to run on an instance of the application updated based on the change.

20. The system of claim 19, wherein, the security analysis includes determining whether the change includes malicious code, and wherein outputting the alert in response to determining that the change includes malicious code.
